(19) United States
(12) Patent Application Publication
(10) Pub. No.: US 2019/0116776 A1
(43) Pub. Date: Apr. 25, 2019

(54) Insect Capturing System

(71) Applicant: Kasey Gonzales, Colorado Springs, CO (US)

(72) Inventor: Kasey Gonzales, Colorado Springs, CO (US)

(21) Appl. No.: 15/790,471

(22) Filed: Oct. 23, 2017

(51) Int. Cl. A01M 1/14

(52) U.S. Cl. CPC A01M 1/14; A01G 9/02

(57) ABSTRACT

An insect capturing system for reducing a population of insects in a flower pot includes a pot that may be filled with soil thereby facilitating a plant to grow in the pot. An adhesive unit is provided and the adhesive unit is selectively coupled to the pot. Insects adhere to the adhesive unit when the insects leave the pot thereby reducing a population of the insects in the pot.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to capturing devices and more particularly pertains to a new capturing device for reducing a population of insects in a flower pot.

### BRIEF SUMMARY OF THE INVENTION

An embodiment of the disclosure meets the needs presented above by generally comprising a pot that may be filled with soil thereby facilitating a plant to grow in the pot. An adhesive unit is provided and the adhesive unit is selectively coupled to the pot. Insects adhere to the adhesive unit when the insects leave the pot thereby reducing a population of the insects in the pot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an adhesive unit of an insect capturing system according to an embodiment of the disclosure.

FIG. 2 is a back view of an adhesive unit of an embodiment of the disclosure.

FIG. 3 is a cross sectional view taken along line 3-3 of FIG. 2 of an embodiment of the disclosure.

FIG. 4 is a perspective in-use view of an embodiment of the disclosure.

FIG. 5 is a perspective view of an alternative embodiment of the disclosure.

FIG. 6 is a front view of an alternative embodiment of the disclosure.

FIG. 7 is a back perspective view of an adhesive unit in an alternative embodiment of the disclosure.

FIG. 8 is a top perspective view of an alternative embodiment of the disclosure.

FIG. 9 is a perspective view of receptacle of an alternative embodiment of the disclosure.

FIG. 10 is a perspective view of tracks of an alternative embodiment of the disclosure.

FIG. 11 is a back perspective view of a receptacle of an alternative embodiment of the disclosure.

FIG. 12 is a perspective in-use view of an alternative embodiment of the disclosure.

FIG. 13 is a front perspective view of receptacle of an alternative embodiment of the disclosure.

FIG. 14 is a front perspective in-use view of an alternative embodiment of the disclosure.

FIG. 15 is a perspective view of a housing of an embodiment of the disclosure.

### DETAILED DESCRIPTION OF THE INVENTION

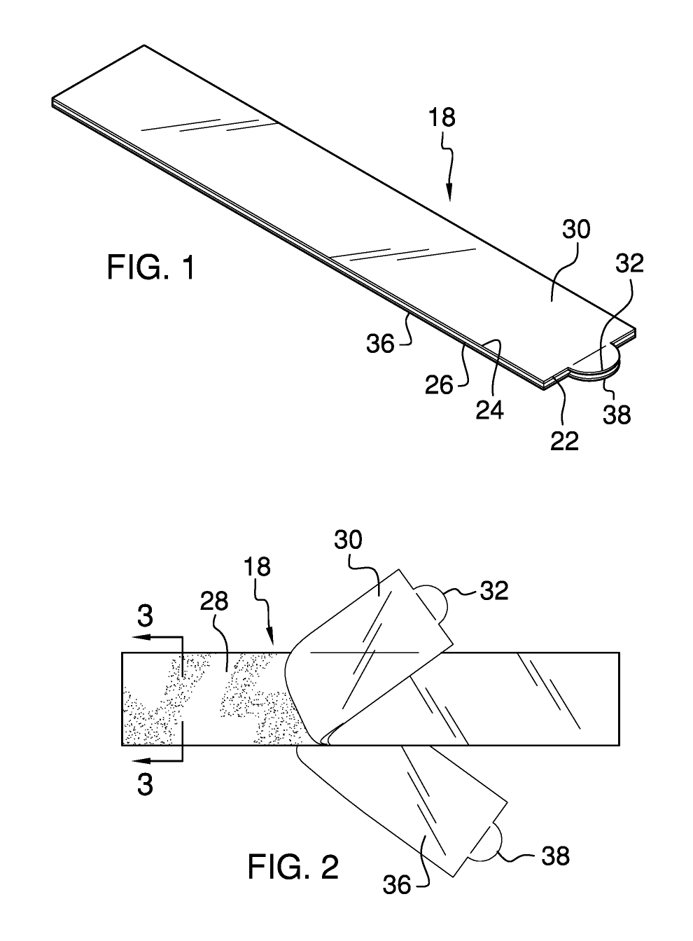

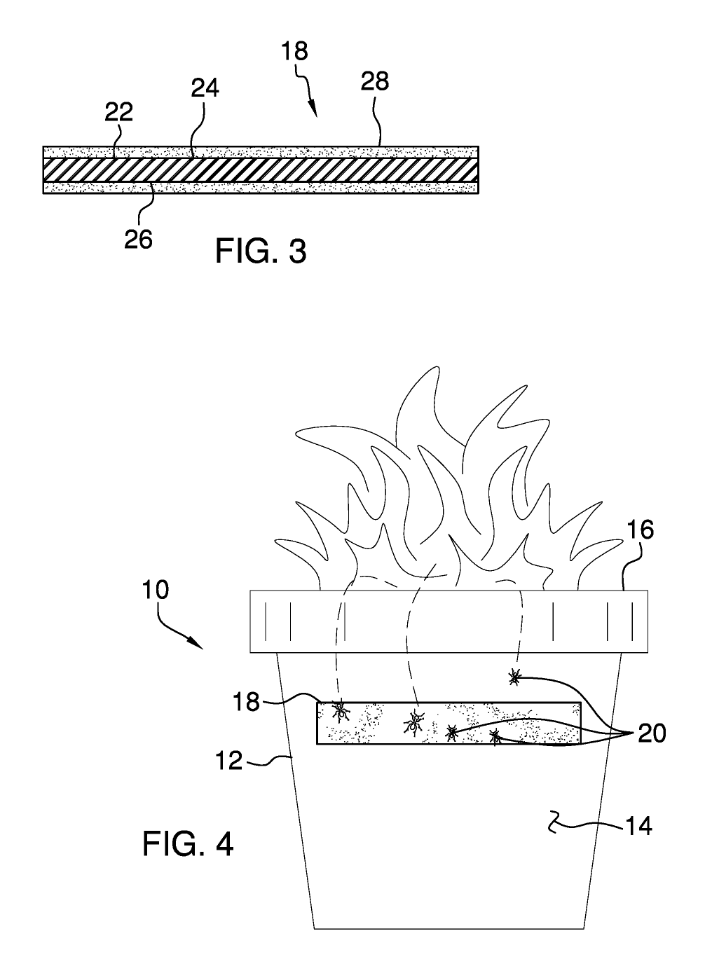

With reference now to the drawings, and in particular to FIGS. 1 through 15 thereof, a new capturing device embodying the principles and concepts of an embodiment of the disclosure and generally designated by the reference numeral 10 will be described.

As best illustrated in FIGS. 1 through 15, the insect capturing system 10 generally comprises a pot 12 that may be filled with soil thereby facilitating a plant to grow in the pot 12. The plant may be a flower, a vegetable plant and any other plant commonly grown in a pot 12. The pot 12 may be a planting pot of any conventional design, including but not being limited to, terra-cotta pots, aerated flowerpots and disposable flowerpots. The pot 12 has an outer surface 14 and an outer surface 14 and the outer surface 14 is open to access an interior of the pot 12.

An adhesive unit 18 is provided and the adhesive unit 18 is selectively coupled to the pot 12. Insects 20, such as gnats and ants, adhere to the adhesive unit 18 when the insects 20 leave the pot 12. In this way the adhesive unit 18 reduces a population of the insects 20 in the pot 12. The adhesive unit 18 comprises a strip 22 that has a first surface 24 and a second surface 26. Moreover, the strip 22 is longitudinally elongated and the strip 22 may be comprised of a deformable material. The strip 22 is positioned on the outer surface 14 of the pot 12 having the strip 22 being horizontally oriented. Additionally, the strip 22 is spaced from the outer surface 14 of the pot 12 in the strip 22 may have a length ranging between approximately 7.0 cm and 15.0 cm.

A first adhesive layer 28 is coupled to the first surface 24 of the strip 22. The first adhesive layer 28 adheres to the outer surface 14 of the pot 12 when the strip 22 is positioned on the pot 12. Additionally, the first adhesive layer 28 completely covers the first surface 24 of the strip 22. The first adhesive layer 28 may be comprised of any non-residual, single use adhesive. A first sheet 30 is removably coupled to the first adhesive layer 28 to protect the first adhesive layer 28. The first sheet 30 is selectively removed from the first adhesive layer 28 to facilitate the first adhesive layer 28 to adhere to the pot 12. A first tab 32 extends outwardly from the first sheet 30 and beyond the strip 22 for gripping and removing the first sheet 30 from the first adhesive layer 28.

A second adhesive layer 34 is coupled to the second surface 26 of the strip 22. The second adhesive layer 34 is exposed with respect to the pot 12 when the strip 22 is positioned on the pot 12. The insects 20 adhere to the second adhesive layer 34 when the insects 20 leave the pot 12 by crawling when the plant in the pot 12 is watered. The second adhesive layer 34 may be comprised of any adhesive that is capable of capturing and retaining insects 20 thereon. A second sheet 36 is removably coupled to the second adhesive layer 34 to protect the second adhesive layer 34. The second sheet 36 is selectively removed from the second adhesive layer 34. A second tab 38 extends outwardly from the second sheet 36 and beyond the strip 22 for gripping and removing the second sheet 36 from the second adhesive layer 34.

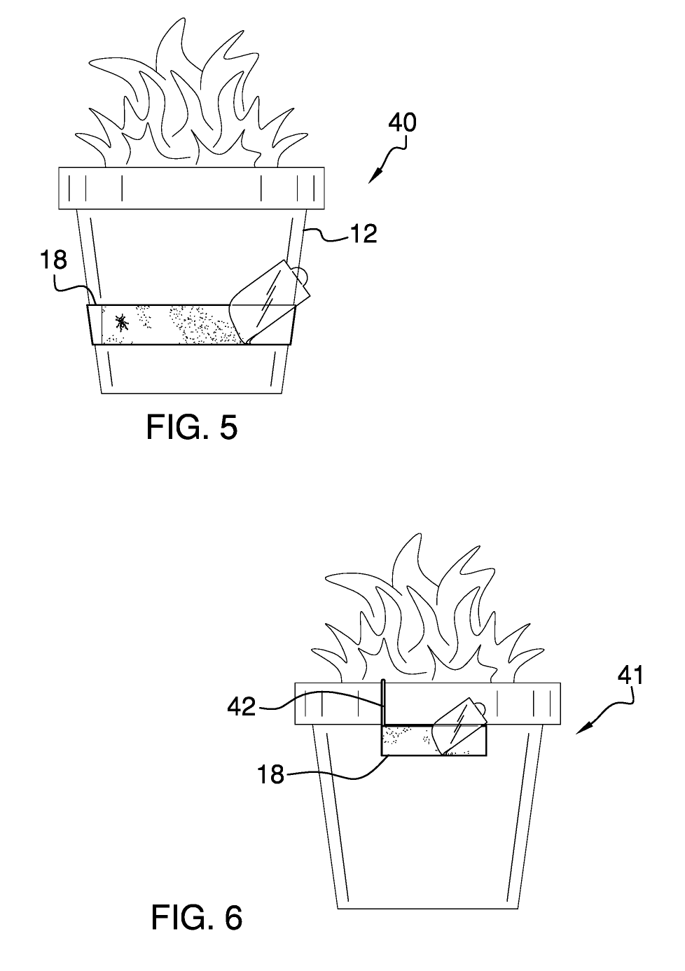

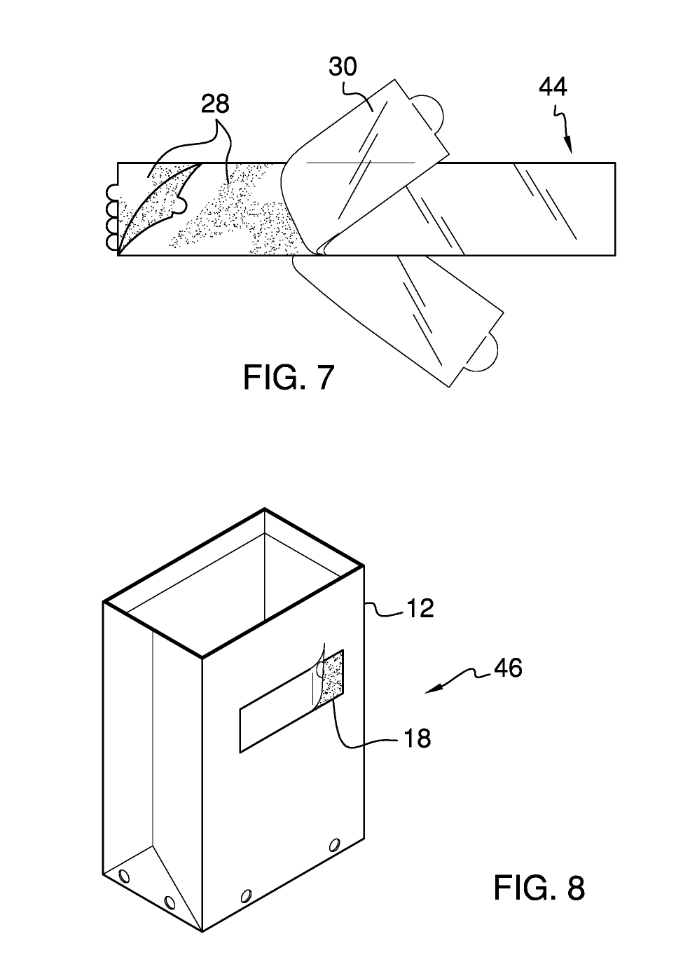

In an alternative embodiment 40 as shown in FIG. 5, the adhesive unit 18 may be continuous such that the adhesive unit 18 forms a closed loop. Thus, the adhesive unit 18 may extend around entire diameter of the pot 12. In an alternative embodiment 41 as shown in FIG. 6, a mating member 42 may extend upwardly from the adhesive unit 18 to engage the outer surface 14 of the pot 12, thereby retaining the adhesive unit 18 on the pot 12. In an alternative embodiment 44 as shown in FIG. 7, a plurality of the first adhesive layers 28 may be positioned on the strip 22 and a plurality of second adhesive layers 34 may be positioned on strip 22. Each of the first 28 and second 34 adhesive layers may be selectively removed from the strip 22 when each of the first 28 and second 34 adhesive layers become depleted.

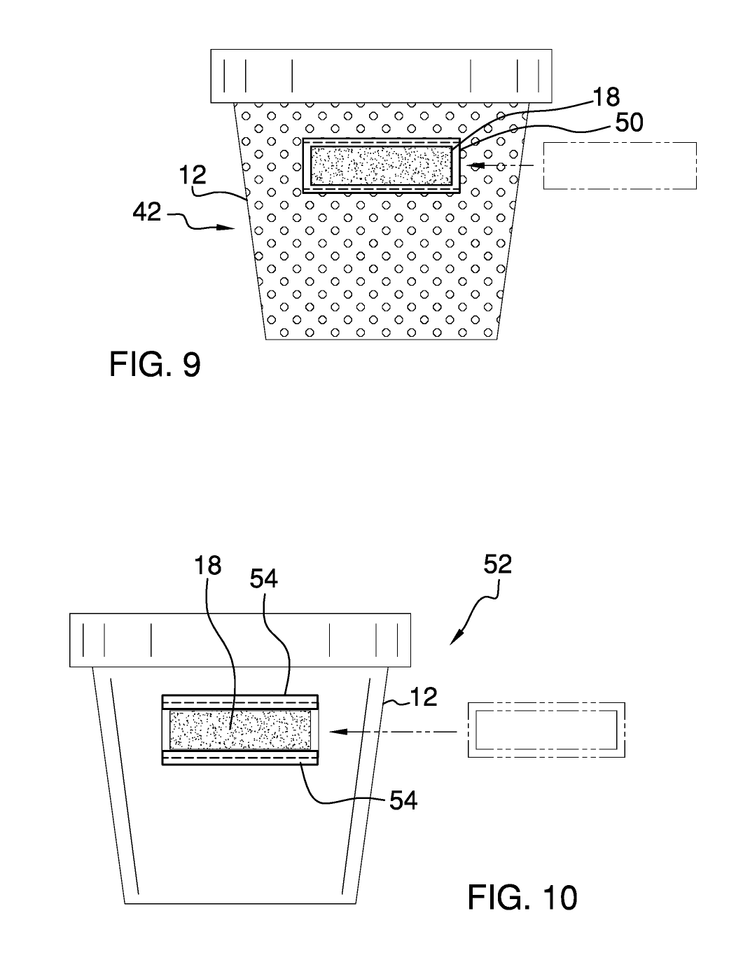

In an alternative embodiment 46 as shown in FIG. 8, the pot 12 may be comprised of a deformable and disposable material. Moreover, the pot 12 in FIG. 8 may be structured in the convention of a paper grocery bag. In an alternative embodiment 48 as shown in FIG. 9, a receptacle 50 may be coupled to the outer surface 14 of the pot 12. The receptacle 50 may slidably receive the adhesive unit 18, thereby removably retaining the adhesive unit 18 on the pot 12. In an alternative embodiment 52 as shown in FIG. 10, a pair of tracks 54 may be provided and each of the tracks 54 may be coupled to the outer surface 14 of the pot 12. The tracks 54 in FIG. 10 may be spaced apart from each other and each of the tracks 54 may slidably receive the adhesive unit 18.

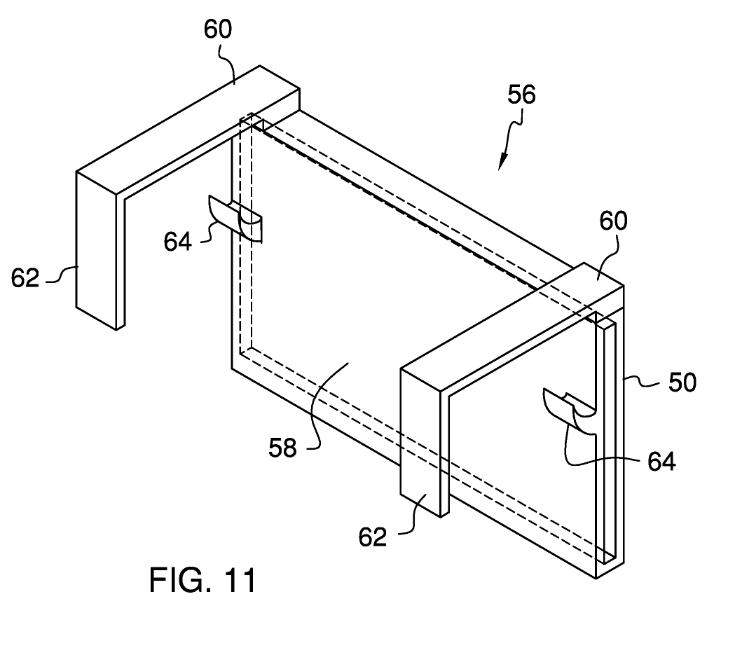

In an alternative embodiment 56 as shown in FIG. 11, the receptacle 50 may be substantially hollow for insertably receiving the adhesive unit 18. The receptacle 50 as shown in FIG. 11 may have a backside 58 and a pair of legs 60 may extend away from the backside 58. A pair of feet 62 may each extend downwardly from an associated one of the legs 60 to engage the outer surface 14 of the pot 12. Additionally, as shown in FIG. 11, a pair of arms 64 may each extend away from the backside 58 of the receptacle 50. The arms 64 in FIG. 11 may engage the outer surface 14 the pot 12 to space the receptacle 50 from the pot 12.

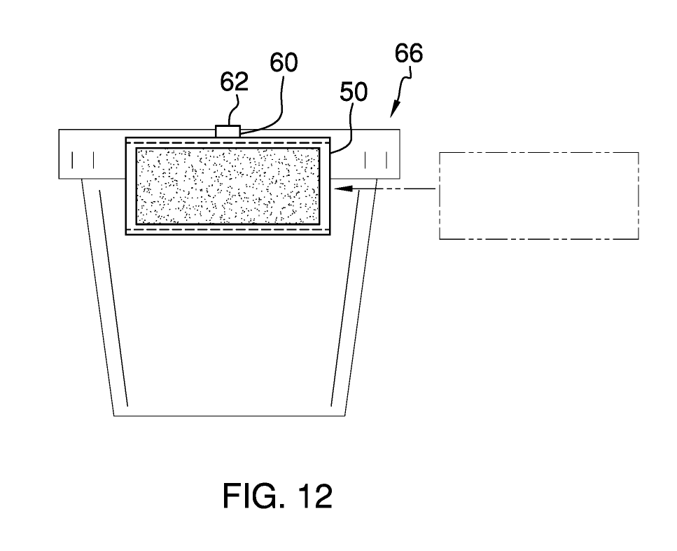

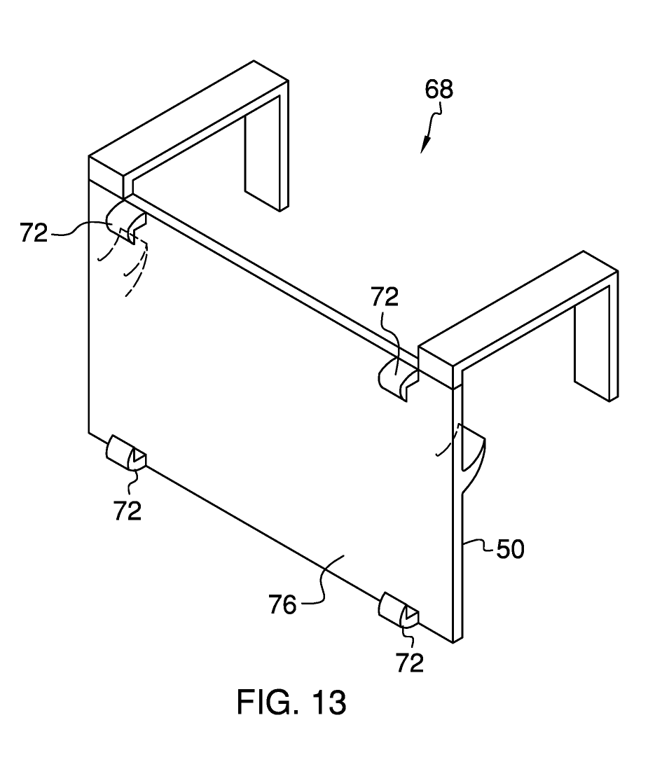

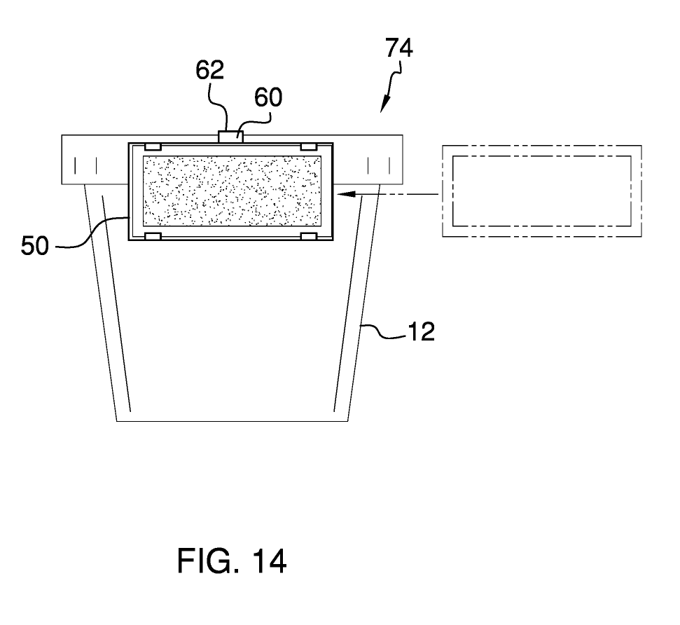

In an alternative embodiment 66 as shown in FIG. 12, a single leg 60 and a single foot 62 may extend away from the receptacle 50 for engaging the outer surface 14 of the pot 12. In an alternative embodiment 68 as shown in FIG. 13 the receptacle 50, as described in the alternative embodiment corresponding to FIG. 11, may have a front side 70. A plurality of clips 72 may be coupled to and extend away from the front side 70 of the receptacle 50 and each of the clips 72 may releasably engage the adhesive unit 18. In an alternative embodiment 74 as shown in FIG. 14, the receptacle 50, as described in the alternative embodiment corresponding to FIG. 13, may have a single leg 60 and a single foot 62 extending away from the receptacle 50 for engaging the outer surface 14 of the pot 12.

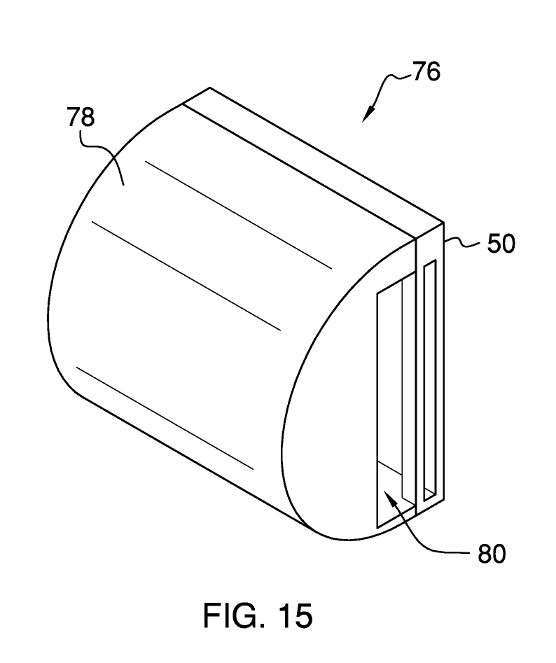

In an alternative embodiment 76 as shown in FIG. 15, a housing 78 may be coupled to the receptacle 50 as the receptacle 50 is described in the alternative embodiment according to FIG. 11. The housing 78 may have an opening 80 therein thereby facilitating the insects 20 to enter the housing 78 and become adhered to the adhesive unit 18.

In use, the adhesive unit 18 is attached to the pot 12 in any of the selected means as described in FIGS. 1 through 15. The second sheet 36 is selectively removed from the second adhesive layer 34 when the adhesive unit 18 is attached to the pot 12. The insects 20 that leave the pot 12 when the plant is watered will become attached to the second adhesive layer 34 when the insects 20 crawl down the outer surface 14 of the pot 12 and when the insects 20 fly out of the pot 12 and bounce on the outer surface 14 of the pot 12. In this way, the population of insects 20 in the pot 12 is reduced, thereby enhancing the health of the plant in the pot 12. The adhesive unit 18 is removable from the pot 12 at any selected time.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect capturing system being configured to trap insects that have gathered in a planting pot, said system comprising:
a pot being configured to be filled with soil thereby facilitating a plant to grow in said pot, said pot having an outer surface and a top end, said top end being open to access an interior of said pot; and
an adhesive unit being selectively coupled to said pot wherein said adhesive unit is continued to have insects adhered thereto when the insects leave said pot thereby reducing a population of the insects in said pot.

2. The system according to claim 1, wherein said adhesive unit comprises a strip having a first surface and a second surface.

3. The system according to claim 2, further comprising a first adhesive layer being coupled to said first surface of said strip, said first adhesive layer adhering to said outer surface of said pot when said strip is positioned on said pot, said first adhesive layer completely covering said first surface of said strip.

4. The system according to claim 3, further comprising a first sheet being removably coupled to said first adhesive layer such that said first sheet protects said first adhesive layer, said first sheet being selectively removed from said first adhesive layer.

5. The system according to claim 2, further comprising a second adhesive layer being coupled to said second surface of said strip, said second adhesive layer being exposed with respect to said pot when said strip is positioned on said pot wherein said second adhesive layer is configured to have the insects adhered thereto.

6. The system according to claim 5, further comprising a second sheet being removably coupled to said second adhesive layer such that said second sheet protects said second adhesive layer, said second sheet being selectively removed from said second adhesive layer.

7. An insect capturing system being configured to trap insects that have gathered in a planting pot, said system comprising:
a pot being configured to be filled with soil thereby facilitating a plant to grow in said pot, said pot having an outer surface and a top end, said top end being open to access an interior of said pot; and
an adhesive unit being selectively coupled to said pot wherein said adhesive unit is continued to have insects adhered thereto when the insects leave said pot thereby reducing a population of the insects in said pot, said adhesive unit comprising:
a strip having a first surface and a second surface,
a first adhesive layer being coupled to said first surface of said strip, said first adhesive layer adhering to said outer surface of said pot when said strip is positioned on said pot, said first adhesive layer completely covering said first surface of said strip,
a first sheet being removably coupled to said first adhesive layer such that said first sheet protects said first adhesive layer, said first sheet being selectively removed from said first adhesive layer,
a second adhesive layer being coupled to said second surface of said strip, said second adhesive layer being exposed with respect to said pot when said strip is positioned on said pot wherein said second adhesive layer is configured to have the insects adhered thereto, and
a second sheet being removably coupled to said second adhesive layer such that said second sheet protects said second adhesive layer,
said second sheet being selectively removed from said second adhesive layer.
